(19) United States
(12) Patent Application Publication
(10) Pub. No.: US 2013/0051079 A1
(43) Pub. Date: Feb. 28, 2013

(54) DECORATIVE LIGHT WITH A CHANGEABLE SHADE

(71) Applicant: Fei Xu, Shenzhen (CN)

(72) Inventor: Fei Xu, Shenzhen (CN)

(21) Appl. No.: 13/219,939

(22) Filed: Aug. 29, 2011

(51) Int. Cl. H01R 33/00

(52) U.S. Cl. 362/640

(57) ABSTRACT

A decorative light includes a light source, two wires, a socket and a shade. The wires have top ends electrically connected to a bottom of the light source by welding. The socket is coated around the bottom of the light source and the top ends of the wires by injection molding. The shade covers the light source and is detachably mounted on the socket. The decorative light can provide a good waterproof effect because the socket seals an opening of the shade to prevent water from infiltrating inside the shade and damaging the light source. Besides, users can change shades having different shapes freely to make the decorative light attractive and interesting.

### BACKGROUND OF THE INVENTION

1. Field of the Invention

The present invention relates to a decorative light, and more particularly to a decorative light with a changeable shade.

2. Description of the Prior Arts

Decorative lights are small colorful lights for decoration or advertisement. A conventional decorative light generally comprises a socket, a light source, two wires and a shade. The light source is mounted on the socket. The wires are electrically connected to the light source. The shade covers the light source and is mounted on the socket. Conventional decorative lights can be produced by an assembly method or an injection molding method.

Steps of assembly method of producing the decorative lights are welding the wires to the light source first, then inserting the light source in the socket and finally mounting the shade on the socket. However, under this method, both the light source and the shade easily move away from the socket and water easily infiltrates into the shade and damages the light source. Besides, the assembly method increases production cost and lowers productivity.

Steps of injection molding method of producing the decorative lights are welding the wires to the light source first, then putting the light source and the wires in the shade and finally molding the socket on an opening of the shade to seal the opening of the shade and fix the light source and the wires. Under this method, the decorative lights are waterproof because the socket seals the opening of the shade securely and production cost can also be reduced. However, the socket molded directly on the opening of the shade makes the shade unchangeable and thereby makes the decorative light tiresome and unexciting for the user. Besides, when the shade is broken, the decorative light must be replaced with a new one even if other components are still working.

To overcome the shortcomings, the present invention provides a decorative light with a changeable shade to mitigate or obviate the aforementioned problems.

### SUMMARY OF THE INVENTION

The main object of the present invention is to provide a decorative light with a changeable shade and to obtain a good waterproof effect.

To achieve the foregoing objective, the decorative light in accordance with the present invention comprises a light source, two wires, a socket and a shade. The wires include top ends electrically connected to a bottom of the light source by welding. The socket is coated around the bottom of the light source and the top ends of the wires by injection molding. The shade covers the light source and is detachably mounted on the socket. The decorative light can provide a good waterproof effect because the socket seals an opening of the shade to prevent water from infiltrating inside the shade and damaging the light source. Besides, users can change shades having different shapes freely to make the decorative light attractive and interesting.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a decorative light with a changeable shade in accordance with the present invention;

FIGS. 2 and 3 are operational perspective views of the first embodiment of the decorative light in FIG. 1;

FIG. 4 is a side view in partial section of the first embodiment of the decorative light in FIG. 1;

FIG. 5 is an enlarged perspective view of a shade of the first embodiment of the decorative light in FIG. 1;

FIG. 6 is an enlarged perspective view of a washer of the first embodiment of the decorative light in FIG. 1;

FIG. 7 is an exploded perspective view of a second embodiment of a decorative light with a changeable shade in accordance with the present invention;

FIG. 8 is an exploded perspective view of a third embodiment of a decorative light with a changeable shade in accordance with the present invention;

FIG. 9 is a side view in partial section of the third embodiment of the decorative light in FIG. 8;

FIG. 9A is an enlarged side view in partial section of the third embodiment of the decorative light in FIG. 8;

FIG. 10 is a side view in partial section of a fourth embodiment of a decorative light with a changeable shade in accordance with the present invention;

FIG. 10A is an enlarged side view in partial section of the fourth embodiment of the decorative light in FIG. 10;

FIG. 11 is an exploded perspective view of a fifth embodiment of a decorative light with a changeable shade in accordance with the present invention;

FIG. 12 is a side view in partial section of the fifth embodiment of the decorative light in FIG. 11; and

FIG. 12A is an enlarged side view in partial section of the fifth embodiment of the decorative light in FIG. 11.

### DETAILED DESCRIPTION OF THE PREFERRED EMBODIMENTS

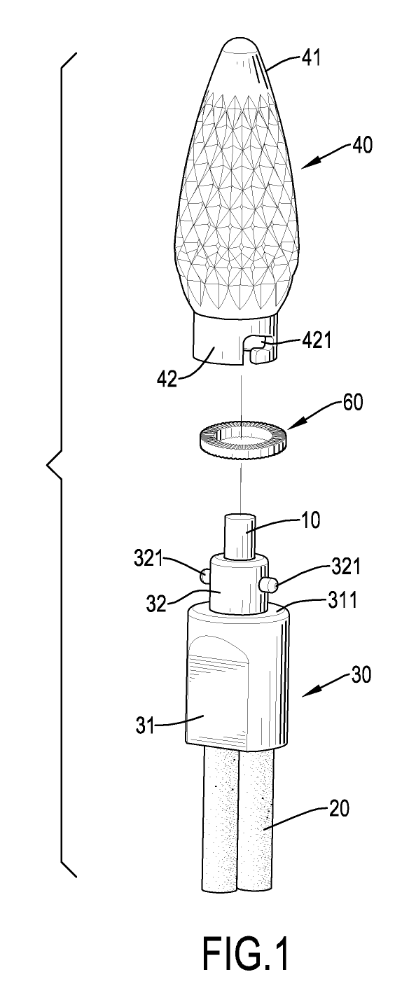

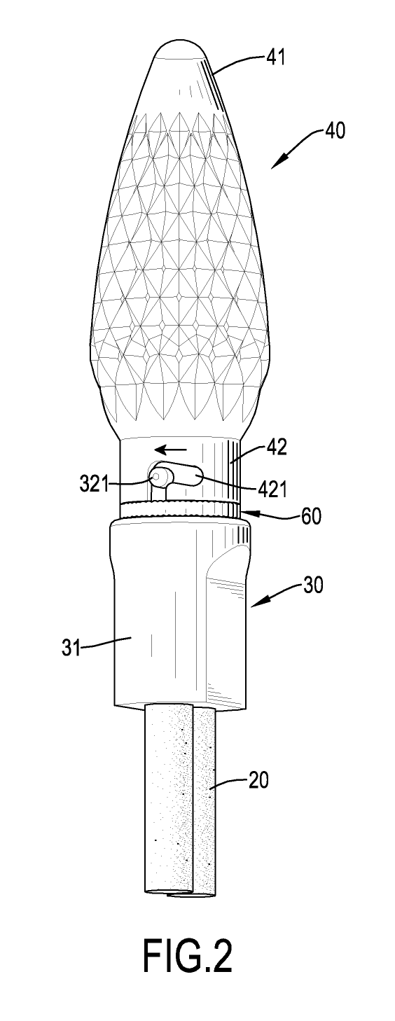

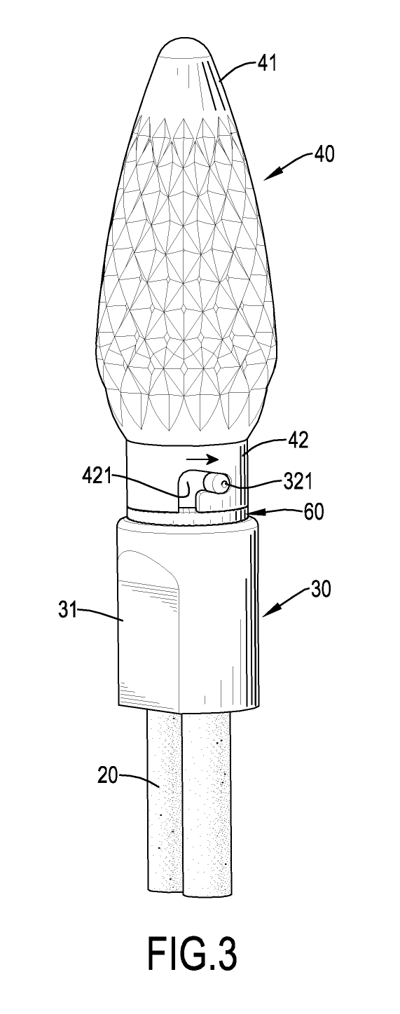

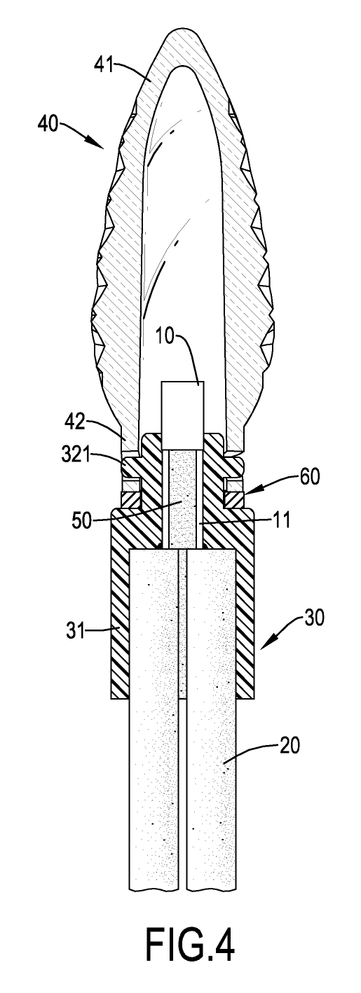

With reference to FIGS. 1 to 4, a decorative light in accordance with the present invention comprises a light source 10, two wires 20, a socket 30, a shade 40 and an insulator 50.

The light source 10 includes a bottom and two leads 11 respectively protruding from a bottom of the light source 10. The light source 10 may be an LED.

The wires 20 include top ends respectively electrically connected to the leads 11 of the light source 10 by welding.

The socket 30 is coated around the bottom of the light source 10 and the top ends of the wires 20 by injection molding.

The shade 40 covers the light source 10, is detachably mounted on the socket 30 and includes a shell 41 and a collar 42. The collar 42 is formed around and protrudes from an opening of the shell 41 and has an open bottom, an external surface and an internal surface.

The insulator 50 is mounted between the leads 11 of the light source 10 and between the top ends of the wires 20. The insulator 50 prevents the leads 11 of the light source 10 from accidentally contacting each other and thereby causing a short circuit due to molding pressure during injection molding of the socket 30. Thus, a high production yield can be obtained.

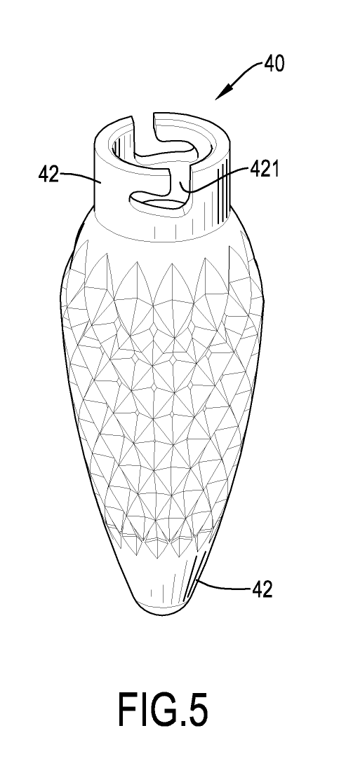

FIGS. 1 to 6 show a first embodiment of the present invention. In the first embodiment, the socket 30 includes a base 31 and an inserted portion 32. The inserted portion 32 is formed on and protrudes from an upper surface of the base 31, corresponds to the collar 42 of the shade 40 and has an annular surface and at least one locking block 321. Each one of the at least one locking block 321 is formed on and protrudes from the annular surface of the inserted portion 32. A diameter of the inserted portion 32 is less than a diameter of the base 31 so as to form a peripheral surface 311 on the base 31 and around the inserted portion 32. The collar 42 of the shade 40 is mounted around the inserted portion 32 of the socket 30 and has at least one L-shaped notch 421. Each one of the at least one notch 421 is formed in the open bottom of the collar 42 for receiving the at least one locking block 321 of the inserted portion 32 of the socket 30 and has an inserting opening and an engaging end. In a preferred embodiment, the inserted portion 32 of the socket 30 has two locking blocks 321 and the collar 42 of the shade 40 has two notches 421.

When the shade 40 is to be assembled with the socket 30, the inserted portion 32 of the socket 30 is inserted into the collar 42 of the shade 40 and the locking blocks 321 of the inserted portion 32 are inserted respectively into the inserting opening of the notches 421 of the collar 42. The shade 40 is then rotated relative to the socket 30 to make the locking blocks 321 of the inserted portion 32 respectively locked in the engaging ends of the notches 421 of the collar 42. Thus, the shade 40 and the socket 30 are assembled. Besides, the shade 40 can be disassembled from the socket 30 by performing the foregoing procedures in reverse. Consequently, users can quickly and effortlessly replace the shade 40 when the shade 40 is broken. Users can also change shades 40 having different shapes freely to make the decorative light attractive and interesting.

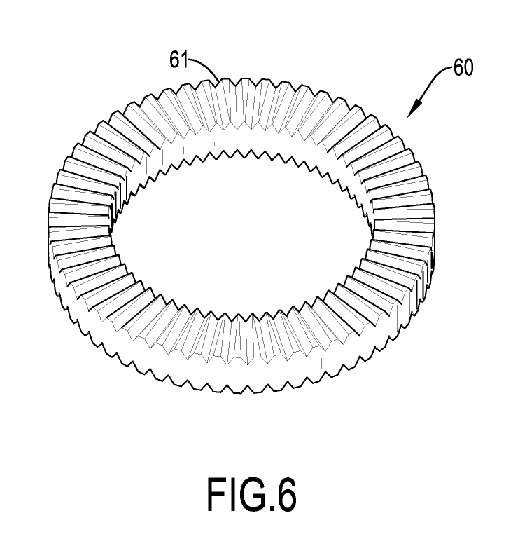

The first embodiment of the decorative light further comprises a washer 60. The washer 60 is mounted around the inserted portion 32 of the socket 30 and is clamped between the peripheral surface 311 of the base 31 of the socket 30 and the collar 42 of the shade 40. An outer diameter of the washer 60 is not less than an outer diameter of the collar 42 of the shade 40. With reference to FIG. 6, the washer 60 includes two rough surfaces 61 formed respectively on an upper surface and a lower surface of the washer 60 so as to increase friction force between the collar 42 of the shade 40 and the washer 60 and between the peripheral surface 311 of the base 31 of the socket 30 and the washer 60 and thereby to ensure that the shade 40 is tightly sealed with the socket 30. Each of the rough surfaces 61 may have multiple V-shaped grooves formed radially in the upper surface and the lower surface of the washer 60.

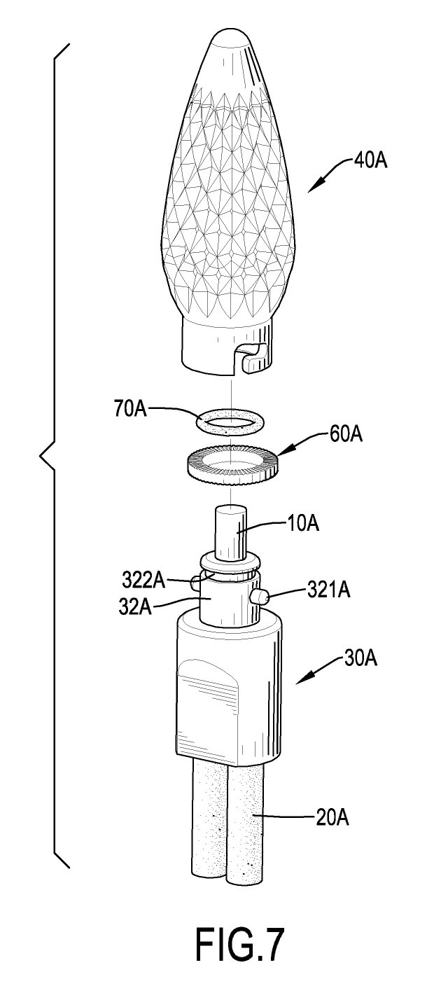

With reference to FIG. 7, a second embodiment is based on the first embodiment, but the inserted portion 32A of the socket 30A further has an annular groove 322A for receiving an elastic waterproof ring 70A to seal the socket 30A and the shade 40A tightly and prevent water from infiltrating inside the shade 40A and damaging the light source 10A. The annular groove 322A is formed in the annular surface of the inserted portion 32A over the locking blocks 321A. A radial width of the waterproof ring 70A is greater than a radial depth of the annular groove 322A of the inserted portion 32A of the socket 30A.

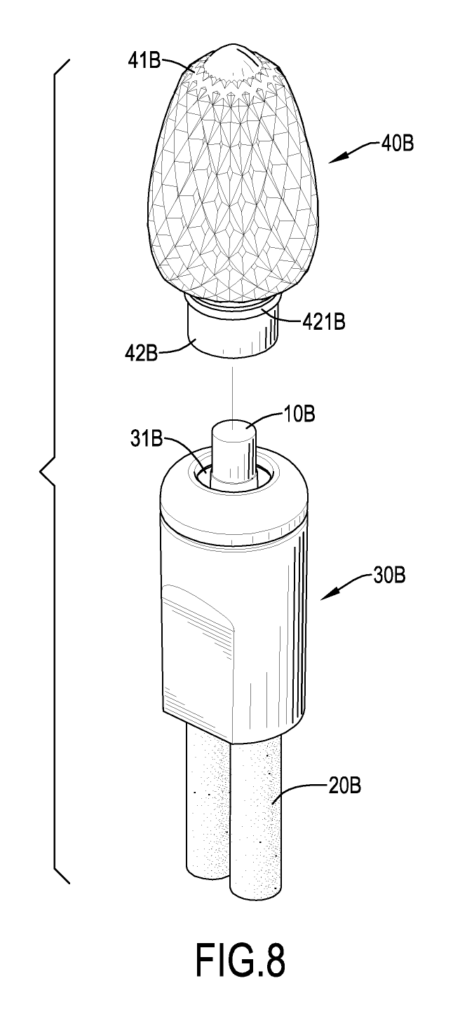

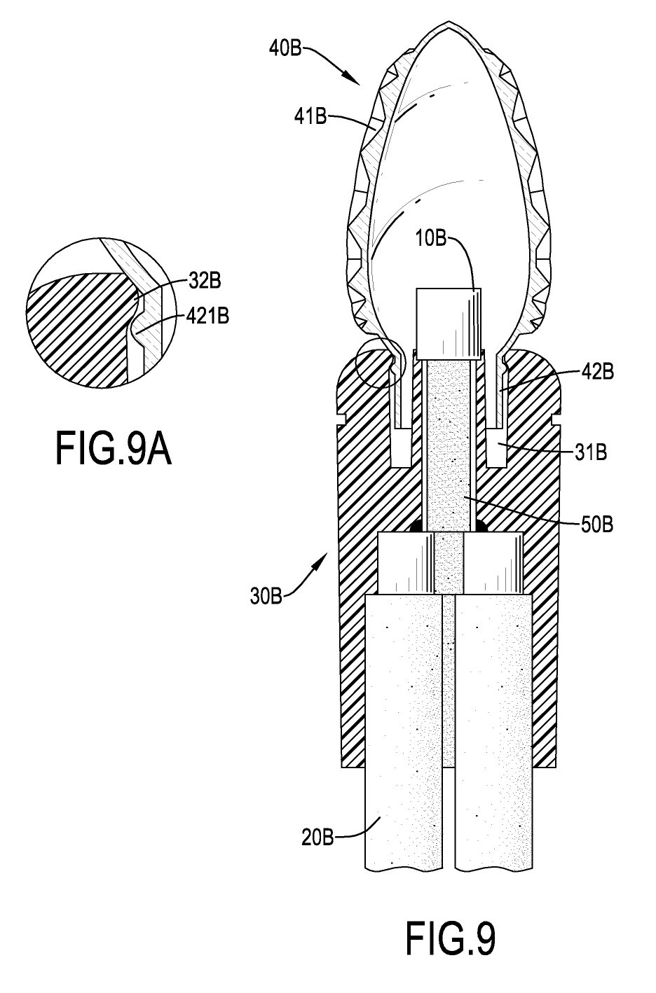

With reference to FIGS. 8, 9 and 9A, in a third embodiment, the socket 30B includes an annular channel 31B and an annular protrusion 32B. The annular channel 31B is formed in an upper surface of the socket 30B, corresponds to the collar 42B of the shade 40B and has an open top and an outer surface. The annular protrusion 32B protrudes from the outer surface of the annular channel 31B and is formed around the open top of the annular channel 31B. The collar 42B of the shade 40B has an annular protrusion 421B. The annular protrusion 421B is formed around and protrudes from the external surface of the collar 42B near the shell 41B. The collar 42B of the shade 40B is inserted into the annular channel 31B of the socket 30B to make the annular protrusion 421B of the collar 42B pass through and engage the annular protrusion 32B of the socket 30B. The annular protrusion 32B of the socket 30B and the annular protrusion 421B of the collar 42B are designed as curved-shape to facilitate assembling of the shade 40B.

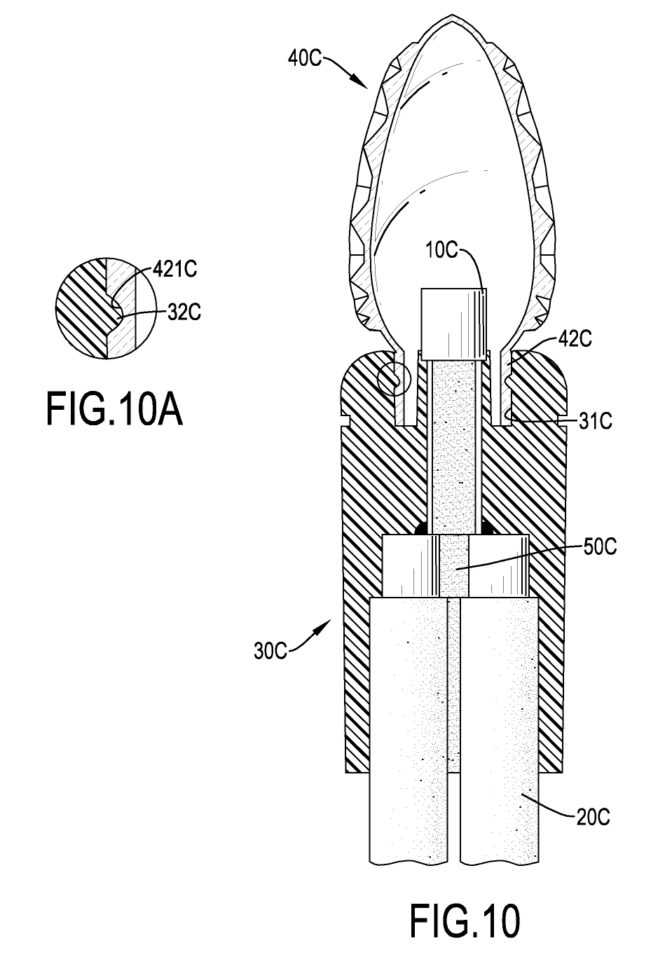

With reference to FIGS. 10 and 10A, in a third embodiment, the socket 30C includes an annular channel 31C and an annular protrusion 32C. The annular channel 31C is formed in an upper surface of the socket 30C and corresponds to the collar 42C of the shade 40C. The annular protrusion 32C is formed around and protrudes from an outer surface of the annular channel 31C. The collar 42C of the shade 40C has an annular groove 421C formed in the external surface of the collar 42C and corresponding to the annular protrusion 32C of the socket 30C. The collar 42C of the shade 40C is inserted into the annular channel 31C of the socket 30C to make the annular protrusion 32C of the socket 30C locked in the annular groove 421C of the collar 42C of the shade 40C.

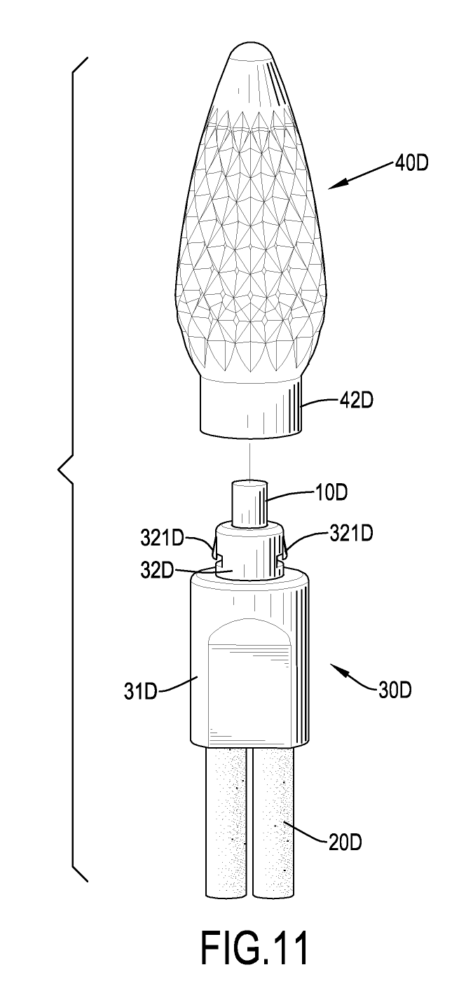

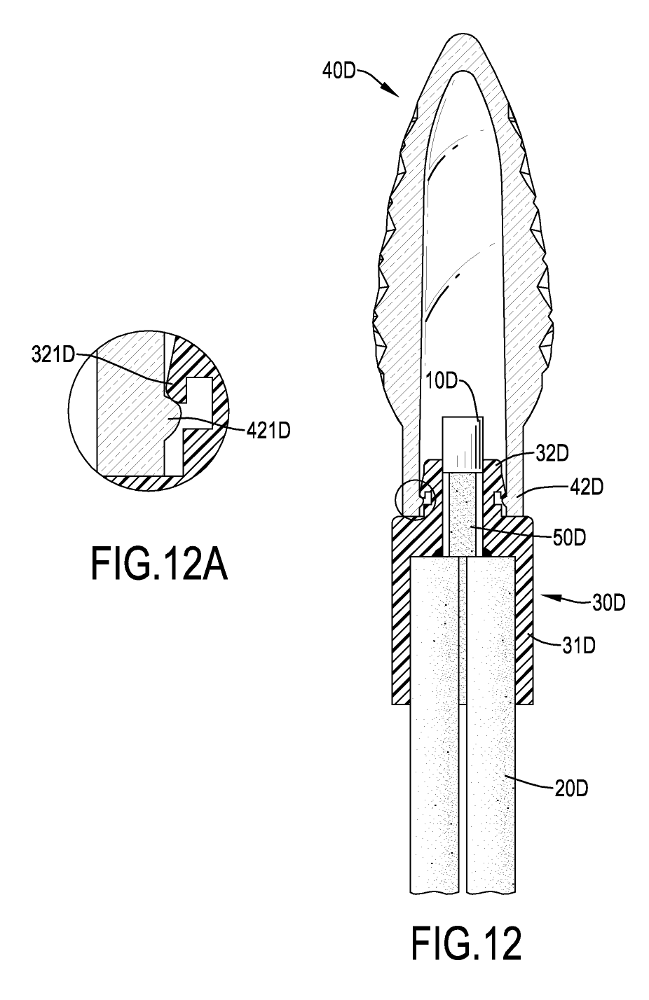

With reference to FIGS. 11, 12 and 12A, in a fifth embodiment, the socket 30D includes a base 31D and an inserted portion 32D. The inserted portion 32D is formed on and protrudes from an upper surface of the base 31D, corresponds to the collar 42D of the shade 40D and has an annular surface and at least one hook 321D. Each one of the at least one hook 321D is formed on and protrudes from the annular surface of the inserted portion 32D. The collar 42D of the shade 40D has an annular protrusion 421D formed around and protruding from the internal surface of the collar 42D. In a preferred embodiment, the inserted portion 32D of the socket 30D has two hooks 321D. The inserted portion 32D of the socket 30D is inserted into the collar 42D of the shade 40D to make the hooks 321D of the inserted portion 32D engage the annular protrusion 421D of the collar 42D of the shade 40D. The hooks 321D of the inserted portion 32D and the annular protrusion 421D of the collar 42D are designed as curved-shape to facilitate assembling of the shade 40D.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A decorative light comprising:
a light source;
two wires including top ends respectively electrically connected to a bottom of the light source by welding;
a socket coated around the bottom of the light source and the top ends of the wires by injection molding; and
a shade covering the light source and detachably mounted on the socket.

2. The decorative light as claimed in claim 1, wherein
the socket includes
a base; and
an inserted portion formed on and protruding from an upper surface of the base and having
an annular surface; and
at least one locking block formed on and protruding from the annular surface of the inserted portion; and
the shade includes
a shell; and
a collar formed around and protruding from an opening of the shell, mounted around the inserted portion of the socket and having
an open bottom; and
at least one L-shaped notch formed in the open bottom of the collar for receiving the at least one locking block of the inserted portion of the socket.

3. The decorative light as claimed in claim 2, wherein the inserted portion of the socket has two locking blocks and the collar of the shade has two notches.

4. The decorative light as claimed in claim 3, wherein
a diameter of the inserted portion of the socket is less than a diameter of the base of the socket so as to form a peripheral surface on the base and around the inserted portion; and
the decorative light further comprises a washer mounted around the inserted portion of the socket and clamped between the peripheral surface of the base of the socket and the collar of the shade.

5. The decorative light as claimed in claim 4, wherein the light source is an LED.

6. The decorative light as claimed in claim 5 further comprising an insulator mounted between two leads of the light source and between the top ends of the wires.

7. The decorative light as claimed in claim 4, wherein the inserted portion of the socket further has an annular groove formed in the annular surface of the inserted portion for receiving an elastic waterproof ring.

8. The decorative light as claimed in claim 7, wherein a radial width of the waterproof ring is greater than a radial depth of the annular groove of the inserted portion of the socket.

9. The decorative light as claimed in claim 1, wherein
the socket includes
an annular channel formed in an upper surface of the socket; and
an annular protrusion formed around and protruding from an outer surface of the annular channel; and
the shade includes
a shell; and
a collar formed around and protruding from an opening of the shell, inserted into the annular channel of the socket and having
an external surface; and
an annular protrusion formed around and protruding from the external surface of the collar and engaging the annular protrusion of the socket.

10. The decorative light as claimed in claim 9, wherein the annular protrusion of the socket and the annular protrusion of the collar of the shade are curved in shape.

11. The decorative light as claimed in claim 9, wherein the light source is an LED.

12. The decorative light as claimed in claim 11 further comprising an insulator mounted between two leads of the light source and between the top ends of the wires.

13. The decorative light as claimed in claim 1, wherein
the socket includes
an annular channel formed in an upper surface of the socket; and
an annular protrusion formed around and protruding from an outer surface of the annular channel; and
the shade includes
a shell; and
a collar formed around and protruding from an opening of the shell, inserted into the annular channel of the socket and having
an external surface; and
an annular groove formed in the external surface of the collar and engaging the annular protrusion of the socket.

14. The decorative light as claimed in claim 13, wherein the light source is an LED.

15. The decorative light as claimed in claim 14 further comprising an insulator mounted between two leads of the light source and between the top ends of the wires.

16. The decorative light as claimed in claim 1, wherein
the socket includes
a base; and
an inserted portion formed on and protruding from an upper surface of the base and having
an annular surface; and
at least one hook formed on and protruding from the annular surface of the inserted portion; and
the shade includes
a shell; and
a collar formed around and protruding from an opening of the shell, mounted around the inserted portion of the socket and having
an internal surface; and
an annular protrusion formed around and protruding from the internal surface of the collar and engaging the hooks of the inserted portion of the socket.

17. The decorative light as claimed in claim 16, wherein the hooks of the inserted portion of the socket and the annular protrusion of the collar of the shade are curved in shape.

18. The decorative light as claimed in claim 16, wherein the light source is an LED.

19. The decorative light as claimed in claim 18 further comprising an insulator mounted between two leads of the light source and between the top ends of the wires.

20. The decorative light as claimed in claim 19, wherein the inserted portion of the socket has two hooks.
